(19) United States
(12) Patent Application Publication
(10) Pub. No.: US 2007/0273543 A1
(43) Pub. Date: Nov. 29, 2007

(54) Tech edge alert prevents mold

(76) Inventor: Salvatore R. Uglietto, Winchester, MA (US)

Correspondence Address: Salvatore R. Uglietto, 42 Mayflower Road, Winchester, MA, 01890, US

(21) Appl. No.: 10/893,695

(22) Filed: Mar. 24, 2003

(51) Int. Cl. G08B 21/00; H04M 11/04

(52) U.S. Cl. 340/657; 340/540; 379/41

(57) ABSTRACT

The Tech Edge Alert will protect homes from mold. In warm and humid climates, if the Air-Conditioner electrical switch is accidentally turned off or it happens to fail in an apartment or a home and the humidity reaches 60 degrees, the humidity controls and equipment that are installed, take control immediately. The Dehumidifying equipment will be put into action removing the humidity in a home or apartment and will continue to operate until the Air-Conditioner is repaired. Furthermore, The owner of the apartment will be notified by telephone. A telephone that is adjusted to dial four telephone numbers, and is connected to the this system regarding the problem that has occurred. Also, if the electrical power fails and the humidity reaches 60 degrees, the owner of the apartment will be notified by telephone and the neighbors will be notified by the Alarm that is installed above the front door of the apartment.

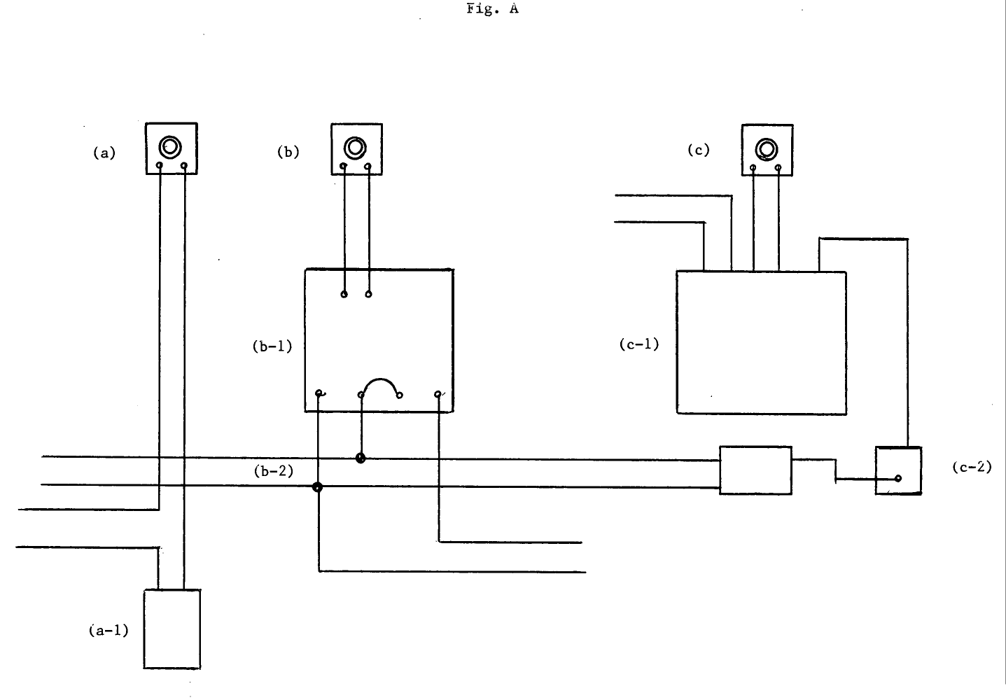

### THE OPERATION OF MOLD PREVENTION

During Hot and Humid weather when people vacation to cooler climates, this system will Prevent Mold from starting by immediately contacting the owner or others involved when the Air-Conditioning Unit fails or Power failure.

The Automatic Telephone Voice Dialer will notify up to Four different telephone locations.

Also, it will notify neighbors with a ringing bell and a Flashing Red Light which will be located at the entrance of their Apartment or Home.

The (a)-(b)-(c) are humidity controls.

The (a) control is set for 65 degrees humidity. If the humidity in the apartment reaches 65 degrees, it would signify that the electric power in the apartment has failed. The (a) control is connected to (a-1), a battery power pack that is wired to an alarm that is installed at top of the front door entrance of the apartment. This alarm will notify all neighbors that the electric power has failed in the apartment. Also, it will notify the owner of the apartment with the telephone (c1) automatic dialer.

The (b+c) controls are set for 60 degrees.

The (b) control is wired to a 110 A C Volt Relay (b-1). (b-2) are the 110 A C Volt electrical lines supplying the relay that supplies the Dehumidifying Equipment.

If the humidity in the apartment reaches 60 degrees, this would signify that the Air-Conditioner has been turned off by mistake or has failed.

The (b-1) control is wired to Dehumidifying equipment and will start operating and continue to operate until the humidity in the apartment drops below 60 degrees.

The (c) control is wired to a telephone voice dialer (c-1). This telephone will have up to four telephone numbers that will be dialed if the humidity reaches 60 degrees.

(c-2) is a battery powered transformer to keep the telephone in tact, if, the electrical power was to fail.

1. The apartment has an alarm installed on the outside of its front door. If the electrical power fails in the apartment, the alarm will sound off notifying all the neighbors.

2. If the air-conditioning system fails, the Tech Edge Alert System will immediately start operating to prevent mold from starting.

3. When the air-conditioning system fails, the telephone computer is equipped to dial up to four telephone numbers notifying the unit owner that the air-conditioning system failed and the Tech Edge Alert System is operating.
